(19) United States
(12) Patent Application Publication
(10) Pub. No.: US 2015/0193150 A1
(43) Pub. Date: Jul. 9, 2015

(54) STORAGE SYSTEM MANAGEMENT COMPUTER AND MANAGEMENT METHOD FOR STORAGE SYSTEM

(71) Applicant: Hitachi, Ltd., Tokyo (JP)

(72) Inventors: Munehiro Kura, Tokyo (JP); Yasufumi Uchiyama, Tokyo (JP)

(73) Assignee: HITACHI, LTD., Tokyo (JP)

(21) Appl. No.: 14/366,441

(22) PCT Filed: Jan. 8, 2014
(86) PCT No.: PCT/JP2014/050111

§ 371 Date: Jun. 18, 2014

(51) Int. Cl. G06F 3/06; G06F 9/50

(52) U.S. Cl. CPC G06F 3/0605; G06F 3/0631; G06F 9/5016; G06F 3/067

(57) ABSTRACT

A storage system management computer stores manager capability information on a task execution capability provided in a plurality of storage managers and management request

task management information defining a correspondence relation between a management request regarding a management of the storage system and a task for realizing the management request. Upon receipt of a management request regarding a management of a storage system, the storage system management computer generates a plurality of tasks for realizing the received management request on the basis of management request—task management information. The storage system management computer allocates a predetermined storage manager as a person in charge of executing a task for each of the generated tasks, on the basis of the manager capability information.

### TECHNICAL FIELD

The present invention relates to a storage system management computer and a management method for a storage system.

### BACKGROUND ART

For example, at a data center, a plurality of storage apparatuses are managed, and a storage manager manages the storage apparatuses. When a new storage apparatus is added at the data center, it is necessary to newly appoint a storage manager in charge of managing the storage apparatus. Even when one storage manager is in charge of a plurality of storage apparatuses, it becomes necessary to allocate a storage manager every time the number of storage apparatuses to be installed increases, hence increase in personnel cost.

Furthermore, even if a storage manager is capable of being in charge of storage apparatuses of a plurality of vendors, the storage manager often is in charge only of a storage apparatus of a particular vendor. In this case, it is not possible to effectively utilize a capability of a storage manager.

Therefore, in PTL 1, a storage manager is dynamically allocated to a required management duty. In a conventional technology described in PTL 1, a storage manager capable of executing a management duty similar to the required management duty is selected and the selected manager executes the required management duty.

### CITATION LIST

### Patent Literature

[PTL 1] WO2012/150628

### SUMMARY OF INVENTION

### Technical Problem

However, in the conventional technology described in PTL 1, the storage manager capable of executing a management duty similar to the required management duty is merely selected, and an aspect in which the management duty is analyzed and tasks are divided so that a plurality of storage managers can execute the tasks is not included. Therefore, it is not possible for a plurality of storage managers to effectively and jointly execute the management duty.

In the foregoing conventional technology, no consideration is given to an aspect in which the storage manager in charge of a storage apparatus of a certain vendor is in charge of another storage apparatus. Therefore, it is not possible to take advantage of a capability of a storage manager capable of dealing with a plurality of vendors.

Further, in the foregoing conventional technology, the storage manager capable of executing the management duty similar to that to be desirably executed is merely selected, and whether it is possible to actually execute the management duty is not guaranteed. Therefore, there is a possibility that the storage manager is not capable of appropriately executing the allocated management duty, and thus, the reliability is low.

The present invention has been achieved in view of the above-described problems, and an object thereof is to provide a storage system management computer and a management method for a storage system with which it is possible to improve a management efficiency.

### Solution to Problem

A storage system management computer according to one aspect of the present invention is a storage system management computer configured to manage a storage system including one or more storage apparatuses used by a host computer, comprising: a memory part; and a processor part configured to perform a predetermined calculation by executing a predetermined computer program stored in the memory part, wherein the processor part stores, into the memory part, manager capability information on a task execution capability provided in a plurality of storage managers and management request—task management information defining a correspondence relation between a management request regarding a management of the storage system and a task for realizing the management request, receives a management request regarding a management of the storage system, generates a plurality of tasks for realizing the received management request on the basis of the management request—task management information, and allocates a predetermined storage manager as a person in charge of executing a task for each of the generated tasks, on the basis of the manager capability information.

### Advantageous Effects of Invention

According to the present invention, a plurality of tasks are generated from a management request, and a predetermined storage manager is allocated, for each task, as a person in charge of execution, and thus, it is possible for a plurality of storage managers to jointly realize one management request, and a management efficiency is improved.

### BRIEF DESCRIPTION OF DRAWINGS

FIG. 1 shows an entire configuration diagram of an information processing system including a storage system.

FIG. 2 shows an explanatory view depicting the configuration of a task allocation computer and a display computer.

FIG. 3 shows a screen example for inputting manager characteristic information.

FIG. 4 shows a screen example for inputting an management request.

FIG. 5 shows a screen example in which a requested task is approved.

FIG. 6 shows a screen example in which a requested task is displayed.

FIG. 7 shows a screen example in which another requested task is displayed.

FIG. 8 shows a screen example in which still another requested task is displayed.

FIG. 9 shows an example of configuration information of a storage management computer.

FIG. 10 shows an example of template management information used for generating a task from a management request.

FIG. 11 shows an example of manager characteristic information in which a capability of each storage manager, for example, is stored.

FIG. 12 shows an example of task management information.

FIG. 13 shows an example of work amount information of a manager who manages a work amount of each storage manager.

FIG. 14 shows a flowchart of a process for inputting a manager characteristic.

FIG. 15 shows a flowchart depicting a display process of a screen into which the manager characteristic is input.

FIG. 16 shows a flowchart of a process for generating a task for realizing a management request.

FIG. 17 shows an example of a task list.

FIG. 18 shows a flowchart depicting an example of a subroutine for generating a task.

FIG. 19 shows a flowchart of a process for allocating a task.

FIG. 20 shows a flowchart of a task ending process.

FIG. 21 shows a flowchart of a process for modifying manager characteristic information, according to a second embodiment.

### DESCRIPTION OF EMBODIMENTS

With reference to the drawings, an embodiment will be described. It should be noted that an embodiment described below does not limit the invention relating to the claims, and various elements described in the embodiment and a combination thereof are not necessarily essential for the means of resolving the invention.

It should be noted that in the below description, information of the present invention is described by using expressions such as “aaa table” and “aaa list”; however, the information may be expressed by using means of expression other than the data structures such as a table, a list, and a database. For this reason, in order to ensure that the information is not dependent on the data structure, “aaa table”, “aaa list”, etc., may be referred to as “aaa information”.

Furthermore, when a content of each information is described, expressions such as “identification information”, “identifiers”, “titles”, “names”, and “ID” are used; these are mutually replaceable.

In the below description, the description may proceed where “program” is used as a subject. Furthermore, a computer program is executed by a processor, thereby a defined process is executed by using a memory and a communications port (communication control device), and thus, the description may proceed by taking the “processor” as the subject. Additionally, the process disclosed with the program as the subject may also be executed by the management computer. Furthermore, the program may be realized partially or entirely by dedicated hardware.

Various programs may be installed onto each computer via a program distribution server or storage media that is readable by a computer. In this case, the program distribution server includes a CPU (Central Processing Unit) and a storage resource, and the storage resource stores a program to be distributed and a distribution program for distributing the program to be distributed to another computer. The CPU distributes the program to be distributed to another computer by executing the distribution program.

It is possible to couple a management computer to an operation computer. The operation computer displays information acquired from the management computer, and gives information and an instruction to the management computer. The operation computer includes at least one input/output device such as a display, a keyboard, a pointer device, a voice synthesis apparatus, and a voice recognition apparatus. It may be also configured that instead of the operation computer, the input/output device is directly coupled to the management computer

Hereinafter, a group of one or more computers which manage a storage system may also called a management system. When the manager is capable of directly operating the management computer, the management computer is the management system. It is possible to call a combination of a management computer and a display computer as the management system. In order to achieve a higher processing speed and a higher reliability, it is also possible to achieve a function as a management computer from a plurality of computers. In that case, the management system includes these computers.

### EMBODIMENT 1

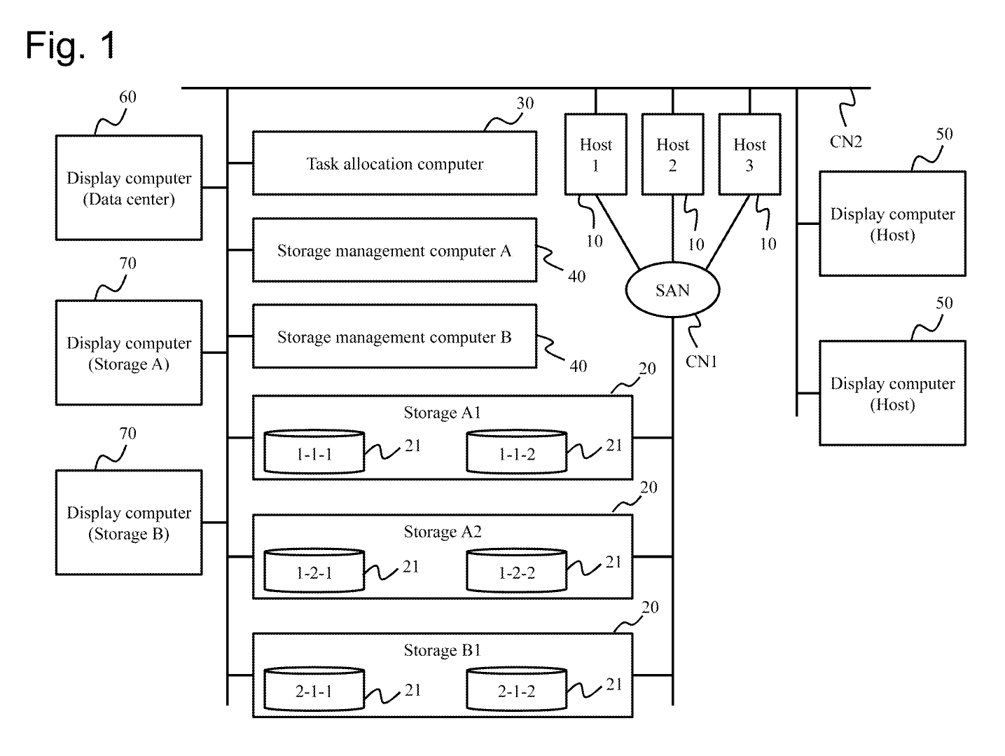

FIG. 1 is a configuration diagram showing a whole of an information processing system including a storage system. The storage system includes a plurality of host computers 10 and a plurality of storage clusters 20. The numbers of the host computers 10 and the storage clusters 20 are not limited to those in the example shown in this figure. The number of elements to be installed, for example, shown in FIG. 1 is not limited to that shown in this figure.

Each storage cluster 20 includes a plurality of storage apparatuses 21. The storage system of the present embodiment includes storage clusters 20 provided from respectively different vendors (a company A and a company B). The storage cluster 20 of the company A, to which a reference symbol A is assigned, is described as 20(A), and the storage cluster 20 of the company B, to which a reference symbol B is assigned, is described as 20(B). In the example of FIG. 1, the company A provides the storage system with storage clusters 20(A1) and 20(A2), and the company B provides the storage system with the storage cluster 20(B1). Besides the example shown in FIG. 1, it may be possible that one or at least three storage clusters 20(A) of the company A are arranged and a plurality of the storage clusters 20(B) of the company B are arranged. The storage system may include a storage cluster of another vendor.

A storage apparatus 21 provided in each storage cluster 20 is coupled, via an I/O (input/output) communication network CN1, to a predetermined host computer 10. The communication network CN1 may be formed as an IP (Internet Protocol) network and may also be formed as an FC-SAN (Fibre Channel—Storage Area Network), for example.

The storage apparatus 21 includes a storage apparatus and a controller (both not shown). The controller reads/writes data into/from the storage apparatus according to a command from the host computer 10, and returns the result to the host computer 10. Further, the controller changes a configuration inside the storage apparatus on the basis of an instruction from a storage management computer 40 described later. Examples of the configuration change inside the storage apparatus include generation or deletion of a logical volume, generation or deletion of a pool, configuration or deletion of a communication path, and generation or cancellation of a copy pair.

As the storage apparatus, for example, a hard disk drive, a flash memory device, an MRAM (Magnetoresistive Random Access Memory), a Phase-Change Memory, an ReRAM (Resistive random-access memory), and an FeRAM (Ferroelectric Random Access Memory) may be used.

For example, an RAID (Redundant Arrays of Inexpensive Disks) group is configured from a physical storage area included in a plurality of storage apparatuses so that a logical volume can be formed from the storage area in the RAID group. The host computer 10 accesses the logical volume to which the communication path is configured to enable reading and writing of data. Further, a so-called thin provisioning volume may be generated to be allocated to the host computer 10.

The storage apparatus 21 in the storage cluster 20 is capable of volume copy inside the storage apparatus 21. That is, it is possible to copy data from one logical volume (including the thin provisioning volume, hereinafter the same applies) existing inside the identical storage apparatus 21 to the other logical volume. Further, the storage apparatus 21 in the storage cluster 20 is capable of volume copy between the logical volume in the storage apparatus 21 and the logical volume in another storage apparatus 21. It is also possible to form a copy pair between the logical volumes in the storage apparatus 21 belonging to respectively different storage clusters 20.

The management system which manages the storage system will now be described. The management system is capable of including a task allocation computer 30, a storage management computer 40, a host-side display computer 50, a data-center-side display computer 60, and a storage-side display computer 70, for example.

Each of the computers 30, 40, 50, 60, and 70 configuring the management system is mutually coupled via a management communication network CN2, and also is coupled to each host computer 10 and each storage apparatus 21. The management communication network CN2 is formed as LAN (Local Area Network), for example. It should be noted that by utilizing an IP communication network, configuration where the I/O communication network CN1 and the management communication network CN2 are commonly used may be employed. The management computers 30 and 40 may use a management protocol such as WMI (Windows (trademark) Management Interface), SSH (Secure SHell), SNMP (Simple Network Management Protocol), and IPMI (Intelligent Platform Management Interface) to enable management of the storage apparatus 21 and the host computer 10.

The task allocation computer 30 generates one or more (generally, a plurality of) tasks on the basis of a management request received from the host-side display computer 50 used by a host manager, and allocates the generated task to a predetermined storage manager from among a plurality of storage managers. A method of generating a task from a management request, a method of allocating a generated task to a storage manager, a method of executing an allocated task, etc., will be described later.

The storage management computer 40 manages the storage cluster 20. The storage management computer 40 is provided for each vendor. In the example of FIG. 1, the storage clusters 20(A1) and 20 (A2) of a vendor company A are managed by the storage management computer 40(A) corresponding to a storage manufactured by the company A. The storage cluster 20(B) of a vendor company B is managed by the storage management computer 40(B) corresponding to a storage manufactured by the company B.

However, when the storage management computer 40 is capable of dealing with a storage manufactured by another company, the storage management computer 40 dealing with one vendor is capable of accessing and managing the storage cluster 20 of the other vendor. For example, in the example shown in the figure, the storage management computer 40(A) is capable of managing the storage cluster 20(B), and the storage management computer 40(B) is capable of managing the storage cluster 20(A).

The host-side display computer 50 is an example of “host-management operation computer”. The host manager, that is, a manager of the host computer 10, is capable of using the host-side display computer 50 to issue a management request to the task allocation computer 30.

The data-center-side display computer 60 is an example of “system-management operation computer”. A data center manager, that is, a manager of a data center having a storage system, is capable of using the data-center-side display computer 60 to give an instruction to each storage manager.

The storage-side display computer 70 is an example of “storage-management operation computer”. The storage manager is capable of using the storage-side display computer 70 to change the configuration of the storage apparatus 21.

In this case, the data center manager is a manager of a whole of the data center, and has more authority over the storage manager. The data center manager is held responsible for employment of a storage manager, creation or approval of a storage planning, etc. The storage manager is a person who manages a storage, and manages the storage by operating the storage management computer 40 by using the storage-side display computer 70. The storage manager is held responsible for configuration management of a storage. The host manager is a person who manages the host computer 10. The host manager is held responsible for management of the host computer 10 and management of an application program running on the host computer 10, for example.

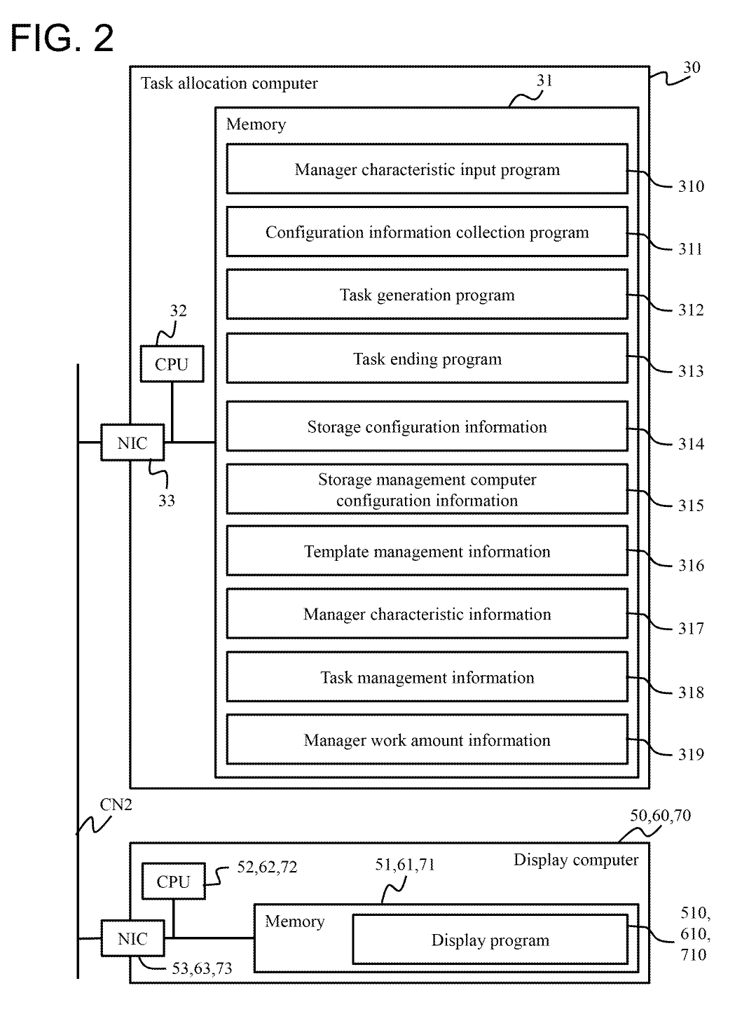

With reference to FIG. 2, the configuration of the task allocation computer 30 and that of the display computers 50, 60, and 70 will be described. Although the configuration of the storage management computer 40 is not shown in the figure, the storage management computer 40 may include a processor, a memory, a communication part, etc., in much the same way as in the task allocation computer 30. In the memory of the storage management computer 40, a management program for managing the storage apparatus 21 which is to be managed, and configuration information showing the configuration of the storage apparatus 21, which is a target for management, are stored, for example.

The task allocation computer 30 includes a memory 31, a processor (in the figure, CPU) 32, and a communication part (in the figure, NIC: Network Interface Card) 33, for example. The memory 31 as “memory part” represents a storage resource such as a ROM (Read Only Memory), a RAM (Random Access Memory), and an auxiliary storage apparatus.

The memory 31 stores various programs 310, 311, 312, and 313, and various management information 314, 315, 316, 317, 318, and 319. It should be noted that the memory 31 stores an operating systems, various drivers, etc., however, these are not illustrated in the figure.

A brief outline of the computer programs 310 to 313 will be first described, and then, a brief outline of the management information 314 to 319 will be described.

A manager characteristic input program 310 is a computer program used by a data center manager. The data center manager uses the manager characteristic input program 310 to input a characteristic about each storage manager (capability about storage management) into the task allocation computer 30 and to register the same with the manager characteristic information 317.

As described later, the data center manager is capable of inputting the characteristic of the storage manager, for only a task about a PP (program products) license provided in the storage apparatus 21. The PP license is a computer program that needs to be installed in order to utilize a function of the storage apparatus 21. That is, when the PP license is not registered with the storage apparatus 21, it is not possible to utilize the function of the PP license in the storage apparatus 21.

The configuration information collection program 311 collects the configuration information of the storage management computer 40 and the configuration information of each storage apparatus 21 and stores the same into the storage management computer configuration information 315 or the storage configuration information 314.

The task generation program 312 generates, when receiving a management request input by the host manager by using the host-side display computer 50, a task necessary for realizing the management request, and allocates a predetermined storage manager for each task. An operation of the task generation program 312 will be described together with a flowchart later; a brief outline of the same will be described first.

The task generation program 312 allocates a storage manager satisfying a predetermined condition as a person responsible for executing the task, from each storage manager capable of executing the task. The predetermined condition is that a storage manager is capable of keeping a work time required for executing a task to a minimum or keeping a payment amount for work required for executing a task to a minimum, for example.

The task generation program 312 displays, on the data-center-side display computer 60, information on a storage manager requesting to execute the task generated from the management request and waits for approval or disapproval from the data center manager to be input. In the below description, a task that is generated from the management request and requested to the storage manager to execute the task may be called a requested task. Further, generation of a task for realizing the management request may be expressed as resolution of the management request to generate a task.

The task generation program 312 transmits and displays, upon receipt of a notification to the effect that the task requested to each storage manager is approved from the data-center-side display computer 60, a request content to the storage-side display computer 70 used by each storage manager requesting to execute each task.

The task ending program 313 manages an execution order of a task and confirms that each task for realizing the management request is executed orderly. Once the completion of a task managed by the storage manager is confirmed, the storage manager uses the storage-side display computer 70 to notify the task allocation computer 30. The notified task ending program 313 applies an instruction to execute the task, to the storage-side display computer 70 used by a storage manager responsible for a task to be executed next.

Once the completion of all the tasks necessary to realize the management request is confirmed, the task ending program 313 notifies the host manager from whom the management request was made and a person responsible for a data center who is a person responsible for a whole of the data center, of the completion of the management request. More specifically, the task ending program 313 transmits data for announcing the completion of the management request, to the host-side display computer 50 used by the host manager from whom the request was made and the data-center-side display computer 60 used by the person responsible for a data center.

In this case, it is possible to manage a period during which each task for realizing the management request is executed by using a schedule management function not shown, for example. For example, the task generation program 312 uses the schedule management function to decide a schedule manager in charge of each task so that each task is completed orderly by a designated due date. With the assistance of the schedule management function, the task generation program 312 decides the storage manager to execute each task in consideration of a work situation, a work schedule, etc., of each storage manager.

Next, the management information 314 to 319 will be briefly described. Some management information will be described later by using a figure. It should be noted that it is possible to save a history of the management information 314 to 319 in the memory 31, and thus, the data center manager or the storage manager can refer to the history of the management information where necessary.

The storage configuration information 314 is information collected by the task allocation computer 30 from each storage management computer 40. The storage configuration information 314 is information on the configuration of a storage such as a volume provided in the storage apparatus 21, pool, a communication path with the host computer 10, and a PP license. When the storage configuration information 314 is used, it becomes possible to know the configuration of a volume, the configuration of a pool, a coupling relation between the host computer 10 and the volume, a PP license that can be used, etc.

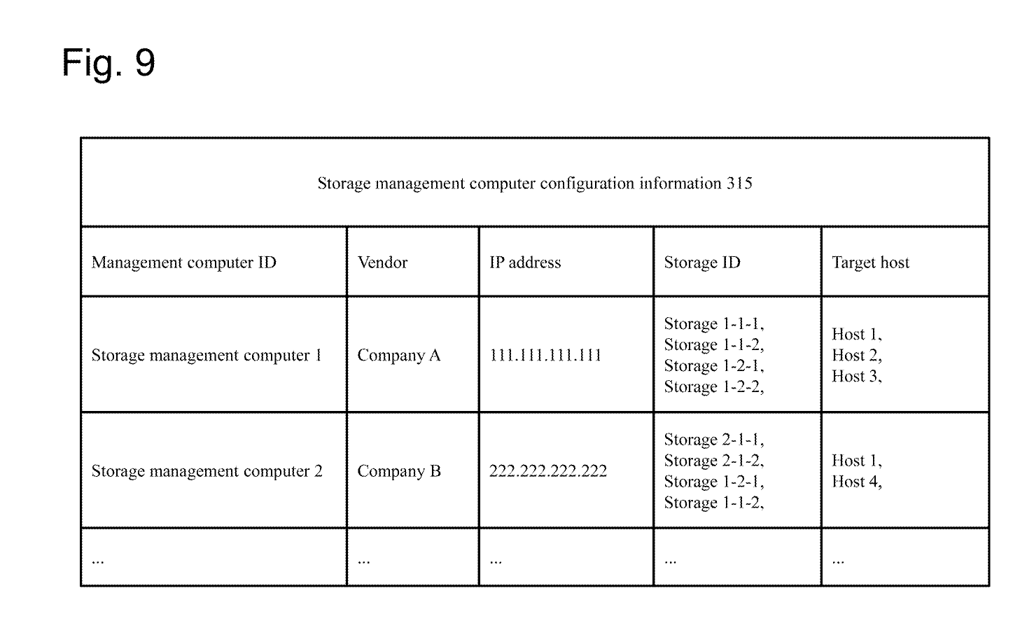

The storage management computer configuration information 315 is information collected, by the task allocation computer 30, from each storage management computer 40. The storage management computer configuration information 315 manages, as described later in FIG. 9, a vendor name of the storage management computer 40, an IP address, identification information of the storage apparatus 21, which is to be managed, etc.

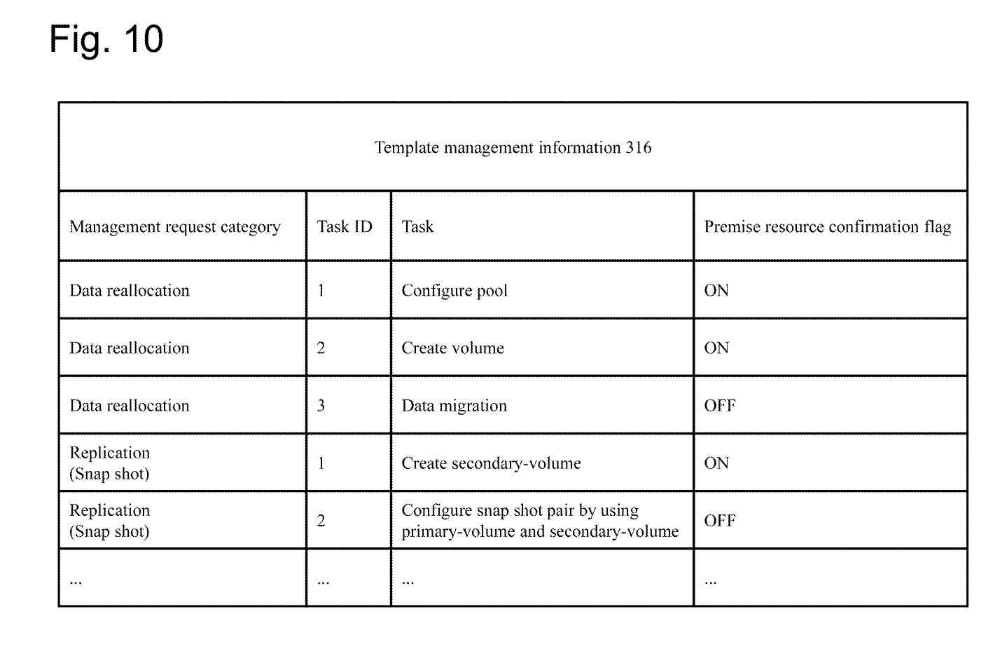

The template management information 316 is an example of “management request-task management information”, and manages a correspondence relation between the management request and the task for realizing the management request, as described later in FIG. 10. The template management information 316 is previously defined by the data center manager, for example, in the task allocation computer 30.

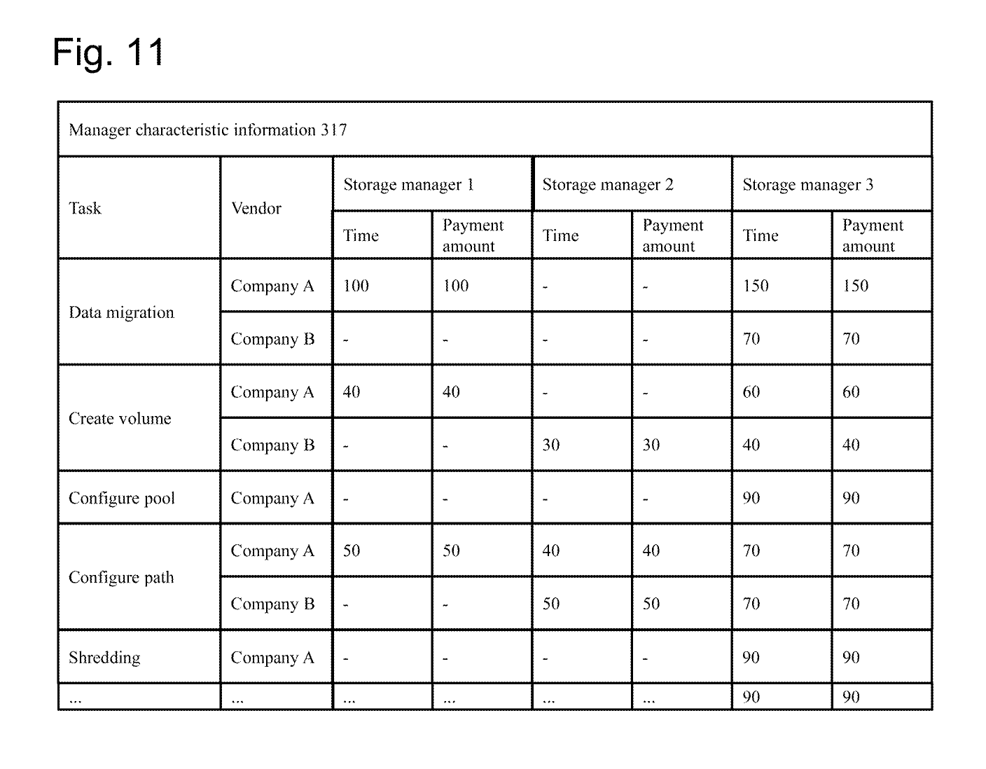

The manager characteristic information 317 is an example of “manager capability information”, and manages a task executable by each storage manager, a work time required for execution of the task, and a payment amount required for execution of the task, for each vendor, as described later in FIG. 11. The manager characteristic information 317 is registered by the data center manager.

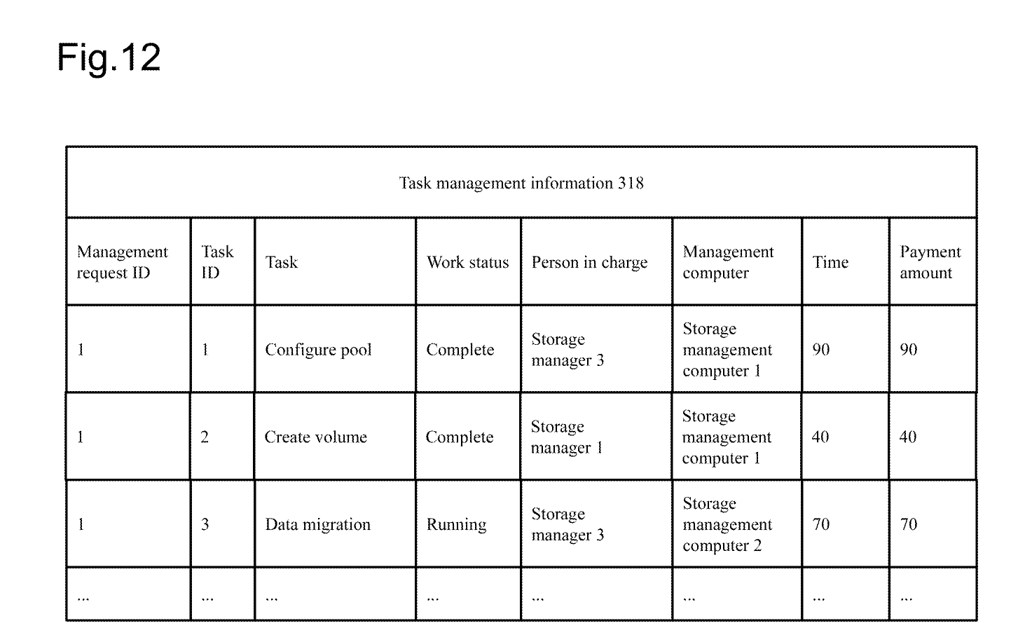

The task management information 318 is information for managing each task generated from the management request. The task management information 318 manages which management request the task results from, to which storage manager the task is allocated, and a work status of the task, etc., as described later in FIG. 12. Examples of the work status of the task include “completion”, “work in progress”, and “not implemented”.

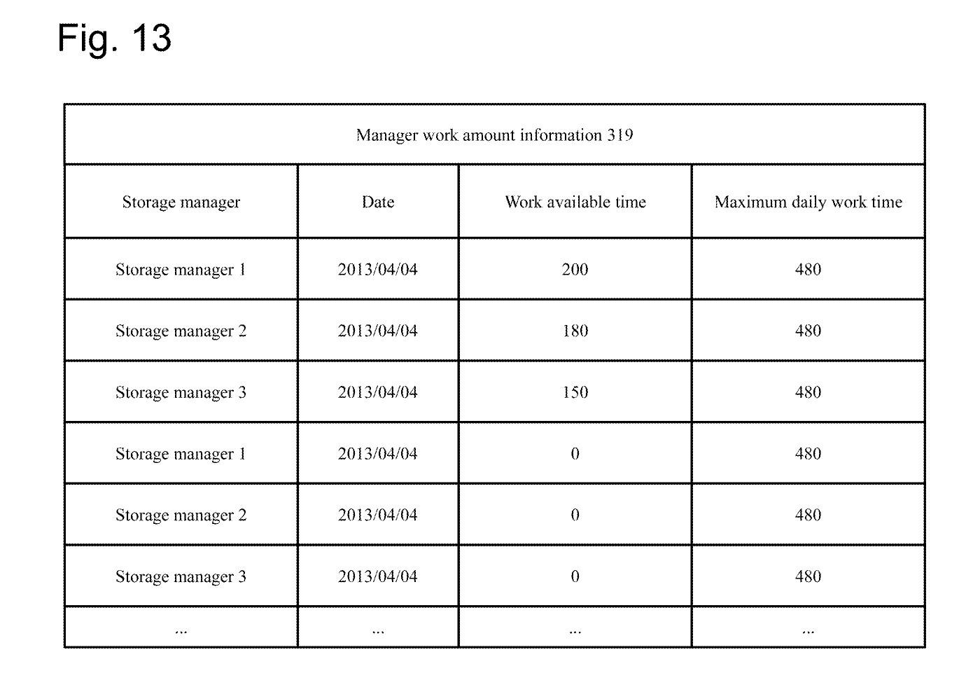

The manager work amount information 319 manages a work amount of the storage manager. The manager work amount information 319 manages an accumulated value of a daily work time of each storage manager, as described later in FIG. 13.

For example, the data center manager may manually input the work time of each storage manager into the manager work amount information 319 at the end of each day. Upon allocation of a task of a next day, the work time is taken into consideration. Instead of the manual input by the data manager, configuration may be that an operation input into the storage-side display computer 70 is monitored, the work time is detected from the monitor result, and the detected work time is automatically input into the manager work amount information 319. Another configuration may be that each storage manager uses the storage-side display computer 70 to manually input the work amount of each storage manager into the manager work amount information 319. Yet another configuration may be that information such as a clock-in time point and a clock-out time point is acquired from attendance management information for managing an attendance of the storage manager, and on the basis of the attendance information, the work time of each storage manager is automatically input into the manager work amount information 319. In either case, the task is allocated to the storage manager with taking into consideration the work time up to the previous day.

The display computers 50, 60, and 70 include memories 51, 61, and 71, processors 52, 62, and 72, and communication parts 53, 63, 73, respectively. In the memories 51, 61, and 71, display programs 510, 610, and 710 for displaying information acquired from the task allocation computer 30 or for inputting the information into the task allocation computer 30 are stored.

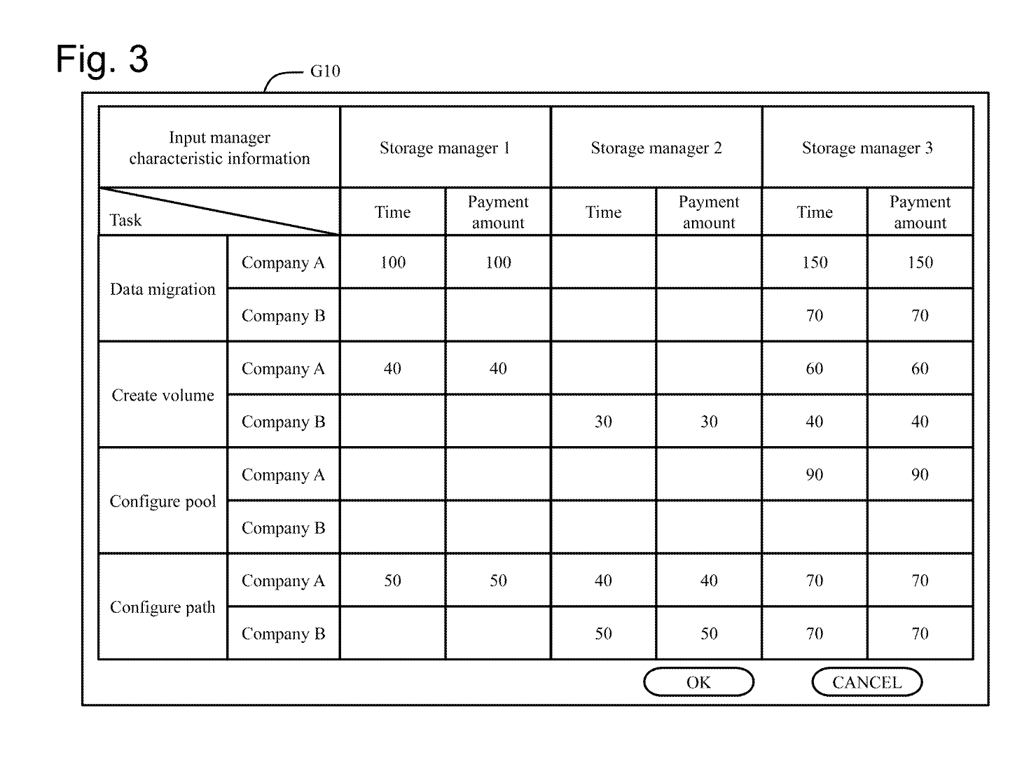

With reference to FIG. 3 to FIG. 8, an example of a screen used in the present embodiment will be described. FIG. 3 shows a screen G10 for inputting manager characteristic information. The manager characteristic information input screen G10 is configured such that the work time and the payment amount for work of each storage manager can be input for each vendor of each task, for example. The work time may be abbreviated as a time and the payment amount for work may be abbreviated as a payment amount, below.

The data center manager displays the screen G10 on the data-center-side display computer 60 so as to input characteristic information (time and payment amount) on each storage manager. It is not possible to input the time and the payment amount for a task that cannot be executed by the storage manager. Conversely, if a task for a certain storage manager has a value in its section titled as the “time” and the “payment amount”, this means that the task can be executed by the storage manager.

It should be noted that when the PP license necessary for executing a task is not registered, the screen G10 does not display a row for the task, or displays the row in which input is disabled. As a result, the data center manager suffices to determine what value to be input, only for a displayed row (time and payment amount), and thus, the efficiency for an input work is improved.

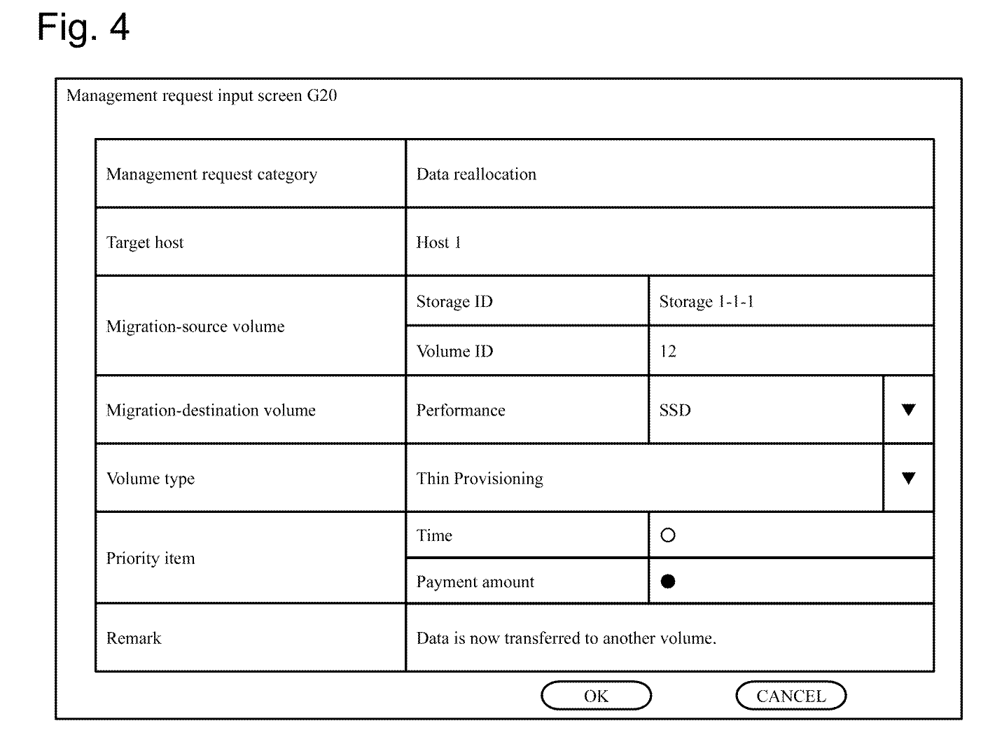

FIG. 4 shows a management request input screen G20 for inputting a management request. The management request input screen G20 is provided, via the host-side display computer 50, to the host manager.

The management request input screen G20 is prepared for each category of the management request. The management request input screen G20 includes a category of a management request, a parameter regarding the management request, a priority item indicating which, the work time or the payment amount for work, is prioritized, and a remark, for example.

In the present embodiment, description proceeds with a case where the category of the management request is “data reallocation”. “Data reallocation” is a process of moving data stored in a certain location in the storage system to another location in the storage system.

A parameter for realizing the “data reallocation” that is the management request includes a “target host”, “migration-source volume”, “migration-destination volume”, and “volume type”, for example.

The “target host” is information for distinguishing the host computer 10 in which data to be rearranged is used. For the sake of simplicity, the host computer 10 uses one storage apparatus 21 only. Further, the host computer 10 designated as the target host and the storage apparatus 21 used by the host computer 10 are to be managed by the same storage management computer 40. As a result, at a time point when the “target host” is designated, the storage apparatus 21, which is to be operated for a configuration change, is uniquely determined.

The “migration-source volume” is information for distinguishing a volume in which the data to be rearranged is currently stored. It is possible to specify the migration-source volume from a storage ID and a volume ID, for example. The “migration-destination volume” is information showing a condition for selecting a volume in which the data to be rearranged is stored. The selection condition of the migration-destination volume includes a volume performance and a volume type, for example. A response performance of a volume generally is determined by the type of storage apparatuses, and thus, in FIG. 4, when the type of the storage apparatuses is designated, the performance that should be provided in the migration-destination volume is designated. It should be noted that an RAID level, for example, may be added to the selection condition.

The “volume type” includes a normal volume and a thin provisioning volume, for example. The thin provisioning volume is a volume that an actual storage area is allocated by as much as storage area used by the host computer 10, and an actual capacity dynamically changes according to the use of the host computer 10.

The “priority item” is information for designating an element emphasized when the management request is realized. The present embodiment is configured such that whether to give importance to a process completion in a possible shortest work time (a total value of work time of each task) or to a process completion with the most reasonable possible payment amount for work (a total value of payment amounts for work of each task) can be exclusively selected. In the figure, a black circle indicates that the item is selected and a white circle indicates that the item is not selected.

The “remark” means an explanation of the management request. The host manager is capable of filling out a reason for requesting to implement the management request, for example, in the “remark”. The data center manager confirms the content to be filled out in the “remark” so as to determine whether to approve the implementation of the management request. It should be noted that when there is a temporal restriction on a completion period of the management request, it is possible to input the temporal restriction in a due date section not shown.

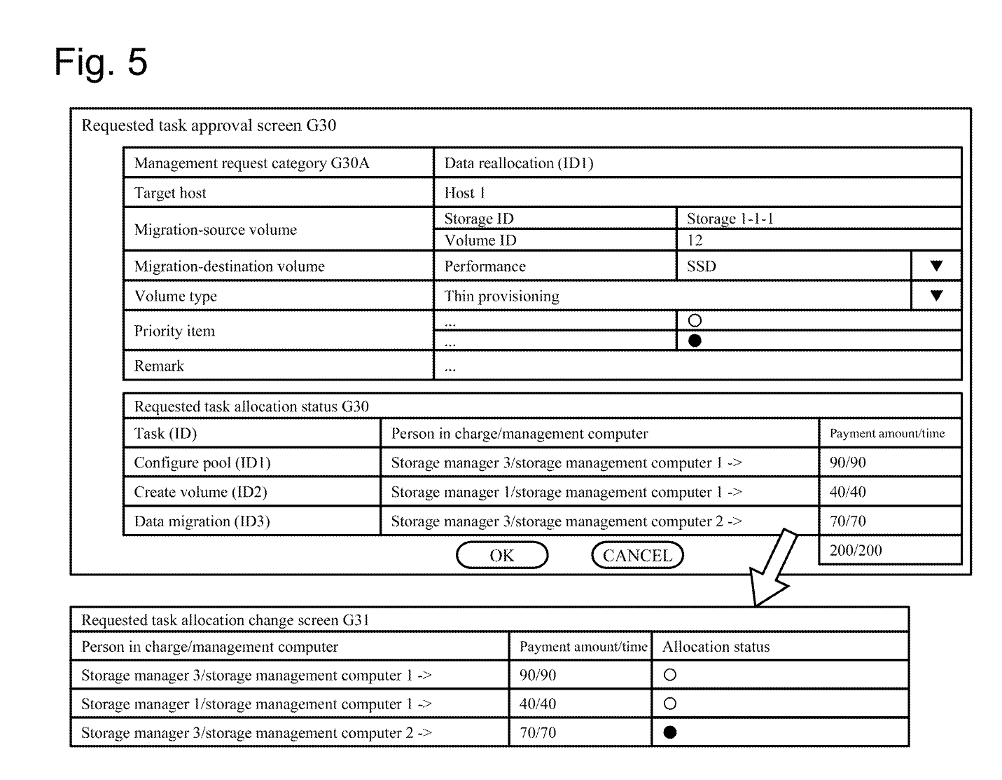

FIG. 5 shows a screen G30 for requesting an approval by the data center manager for a task requested to each storage manager.

The requested task approval screen G30 displays information showing a content of a management request received from the host manager and information showing to which storage manager each task for realizing the management request is allocated.

Above the requested task approval screen G30 shown in FIG. 5, information on the management request is displayed in G30A. The content input from the management request input screen G20 described in FIG. 4 is displayed above the requested task approval screen G30. It should be noted that some contents in FIG. 5 may be omitted. For example the “priority item” and the “remark” in FIG. 5 should be displayed in much as the same way as in FIG. 4; however, these are omitted in FIG. 5.

Below the screen G30 (at the center portion in FIG. 5), an allocation status G30B of each task generated from the management request is displayed. The requested task allocation status 30B includes information for distinguishing each task, information for distinguishing a storage manager that allocated each task, and information on a time and a payment amount required for the execution of each task.

The information for distinguishing each task includes a task name and a task identifier, for example. The information for distinguishing a storage manager, to whom each task is to be allocated, includes an identifier of a storage manager and an identifier of the storage management computer 40 used by the storage manager. In the example shown in FIG. 5, three tasks, “configure pool”, “create volume”, and “data migration” are generated from the management request “data reallocation”.

The task “configure pool” that should be executed firstly of each task is allocated to a storage manager #3. The storage manager #3 configures pool by using a storage management computer 40(1). The task “create volume” that should be executed secondly is allocated to a storage manager #1. The storage manager #1 creates a volume to which the data to be rearranged is migrated by using the storage management computer 40(1). The task “data migration” that should be executed lastly is allocated to the storage manager #3. The storage manager #3 implements the data migration from the migration-source volume to the migration-destination volume by using a storage management computer 40(2).

As shown in FIG. 5, it is possible to execute a plurality of tasks included in one management request by spreading over a plurality of storage managers. For example, as in the storage manager #3 that executes the “configure pool” and the “data migration”, it is possible to allocate a plurality of tasks to one storage manager. As in the storage management computer 40(1) used by the storage manager #3 and the storage manager #1, it is possible for a plurality of storage managers to use the same storage management computer 40.

As in the storage manager #3 using the storage management computer 40(1) and the storage management computer 40(2), it is possible for one storage manager to deal with a plurality of vendors.

Thus, it is possible to allocate a difficult task to a storage manager having high-level skills. It is possible to allocate a simple task to a storage manager not having high-level skills. However, the payment amount for work of the storage manager having high-level skills generally is higher than the payment amount for work of the storage manager not having high-level skills.

When the storage manager has skills dealing with a plurality of vendors, the storage manager is capable of executing a task by using either the storage management computer 40 provided by the same vendor as that of the storage apparatus 21, which is to be operated, or the storage management computer 40 provided by a vendor different therefrom.

At a lower part of FIG. 5, a screen G31 for changing a storage manager, to whom a requested task is allocated, is shown. When the data center manager selects a task for which the allocation is desirably changed from the requested task allocation status 30B, the requested task allocation change screen G31 is displayed.

The requested task allocation change screen G31 displays a candidate of a storage manager capable of executing a task to be changed. The example of FIG. 5 shows a case where the storage manager executing a task “data migration” is desirably changed. The allocation change screen G31 displays information on a pair of the storage manager and the storage management computer 40 capable of executing the “data migration”. From among these pairs, a currently selected pair is shown with a black circle.

The data center manager operates an OK button when the task allocation is approved, and operates a cancel button when the same task is not approved. A title of the button may be randomly chosen. An “approval button” and a “non approval button” may be chosen.

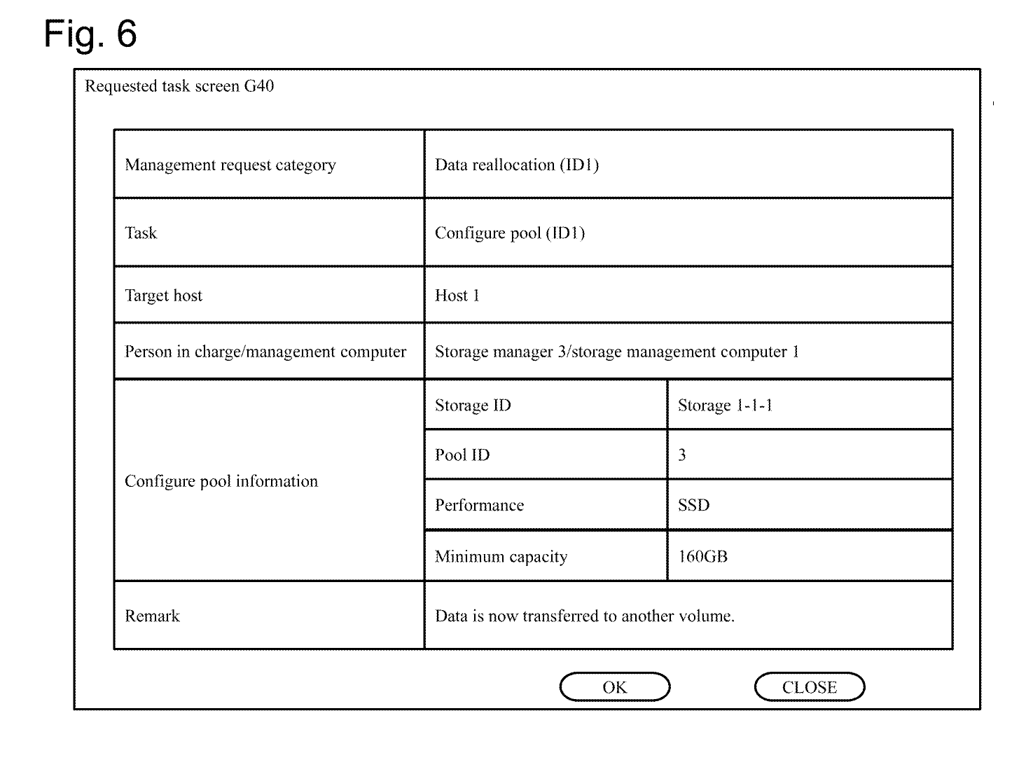

FIG. 6 to FIG. 8 show an example of a requested task screen presented to each storage manager to which a task is allocated. Each storage manager logs in to the task allocation computer 30 via the storage-side display computer 70 so as to confirm the task allocated to each storage manager.

FIG. 6 is a requested task screen G40 provided to the storage manager to which the task “configure pool” that should be executed firstly for realizing the management request is allocated.

The requested task screen G40 includes: information for distinguishing a management request, for example; information for distinguishing a task requested to the storage manager; information for distinguishing a target host; information for distinguishing a storage manager, i.e., a person in charge (person responsible for execution); information for distinguishing the storage management computer 40 used for execution of a task; a parameter necessary for executing a requested task; and a remark.

Upon completion of the task allocated to the storage manager, the storage manager inputs a value indicating a completion result of the task into a parameter section. For example, upon creation of a pool, the storage manager to which the task “configure pool” is allocated inputs information for distinguishing the created pool (pool ID=3) into the screen G40, and operates the OK button. As a result, an execution result of the task “configure pool” is carried over to a next task.

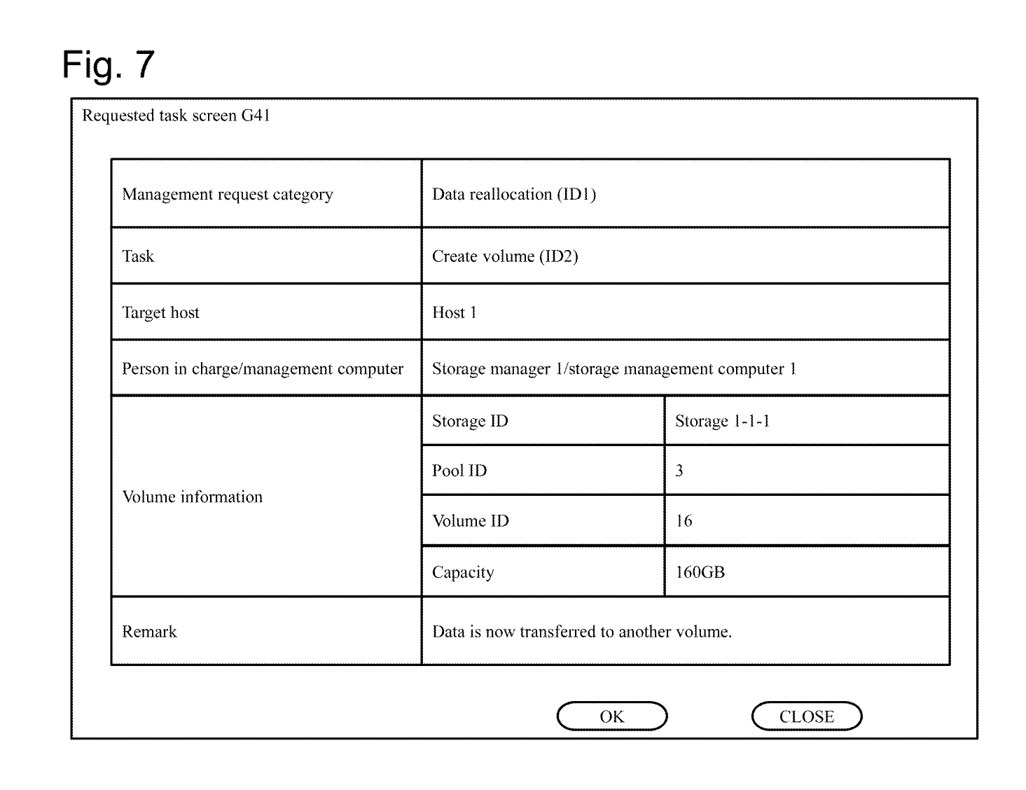

FIG. 7 shows a requested task screen G41 presented to the storage manager to which the task “create volume” that should be executed secondly is allocated. The screen G41 and the screen G40 described in FIG. 6 are common in basic configuration; however, a contents to be displayed differs. For example, in the screen G40 of the pool configuration task shown in FIG. 6, the volume information is not displayed. Further, in the screen G41 in FIG. 7, a value of the pool ID input into the screen G40 in FIG. 6 is displayed.

Upon creation of the migration-destination volume, the storage manager to which the task “create volume” is allocated inputs information for distinguishing the created migration-destination volume (volume ID=16), into the screen G41, and operates the OK button. As a result, an execution result of the task “create volume” is carried over to a next task.

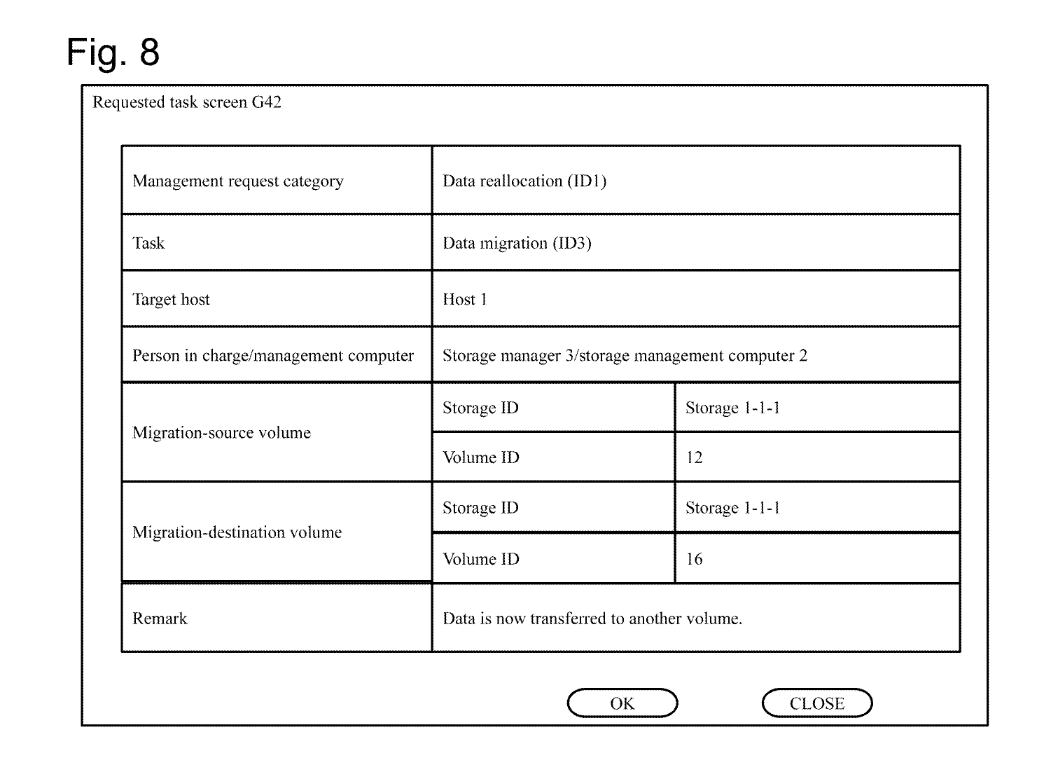

FIG. 8 shows a requested task screen G42 presented to the storage manager to which the task “data migration” that should be executed thirdly (lastly) is allocated. The screen G42 also is common in basic configuration to the above-described screens G40 and G41; however, a content to be displayed differs. This is because the content to be displayed on each requested task screen relies on a content of the task. On the screen G42, an execution result of the preceding task also is displayed.

With reference to FIG. 9 to FIG. 13, the management information used in the present embodiment will be described. FIG. 9 shows the configuration of the storage management computer configuration information 315. The storage management computer configuration information 315 manages a management computer ID, a vendor, an IP address, a storage ID, and a host ID, for example, in an associated manner.

The management computer ID is information for distinguishing each storage management computer 40. The vendor is information for distinguishing the vendor of the storage management computer 40. The IP address is an IP address of the storage management computer 40. The storage ID is information for distinguishing the storage apparatus 21 under the control of the storage management computer 40. The host ID is information for distinguishing the host computer 10 that uses the storage apparatus 21 under the control of the storage management computer 40.

FIG. 10 shows the configuration of the template management information 316. The template management information 316 manages a management request category, a task ID, a task, and a premise resource confirmation flag, for example, in an associated manner.

The management request category is information for distinguishing a kind of the management request. The task ID is information for distinguishing each task necessary for realizing the management request. The task is information showing a name or a content of each task. When the task name indicates a task content, the task name, instead of the task content, is stored in the template management information 316.

The premise resource confirmation flag is information indicating whether it is necessary to confirm whether a resource that is a premise to execute a task exists. When the confirmation is necessary, “OK” is configured, and when the confirmation is not necessary, “OFF” is configured.

It is possible to automatically configure the premise resource confirmation flag on the basis of the storage configuration information 314. For example, in a case of the task “configure pool”, the pool capable of creating a volume being present is a premise when the task is executed. In a case of the task “create volume”, unused volume being present in the configured pool is a premise when the task is executed.

FIG. 11 shows the configuration of the manager characteristic information 317. The manager characteristic information 317 manages the work time and the payment amount for work of a task for each vendor. A task to which a value is not configured means a task not executable by the storage manager.

FIG. 12 shows the configuration of the task management information 318. The task management information 318 manages a management request ID, a task ID, a task, a work status, a person in charge, a management computer, a work time, and a payment amount for work, for example, in an associated manner.

The management request ID is information for distinguishing the management request received from the host manager. The task ID is information for distinguishing each task generated in order to realize the management request. The task is a name or a content of a task. The work status is information indicating an execution status of a task. The person in charge is information for distinguishing the storage manager requested to execute a task (storage manager to which a task is allocated). The management computer is information for distinguishing the storage management computer 40 used for executing a task. The work time is a time required for executing a task. The payment amount for work is a cost required for executing a task, that is, a cost of the storage manager required for executing the task.

FIG. 13 shows the configuration of the manager work amount information 319. The manager work amount information 319 manages information for distinguishing a storage manager, a date, a work available time, and a maximum daily work time, for example, in an associated manner. The work available time is a value obtained by subtracting a current accumulated work time from the maximum daily work time. As a general rule, it is not possible to request a storage manager having a zero work available time to execute a new task.

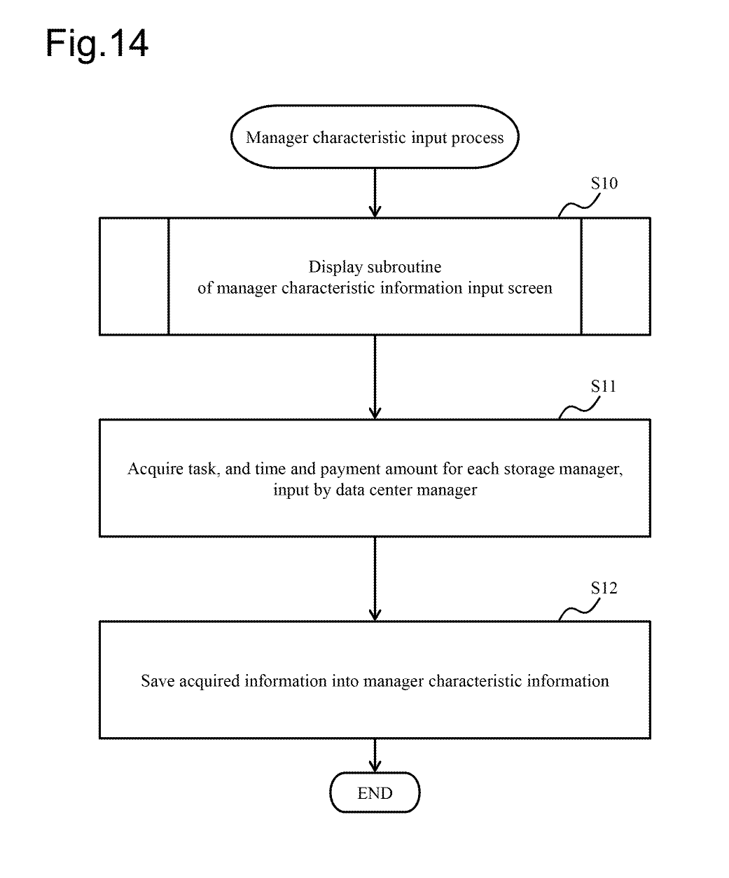

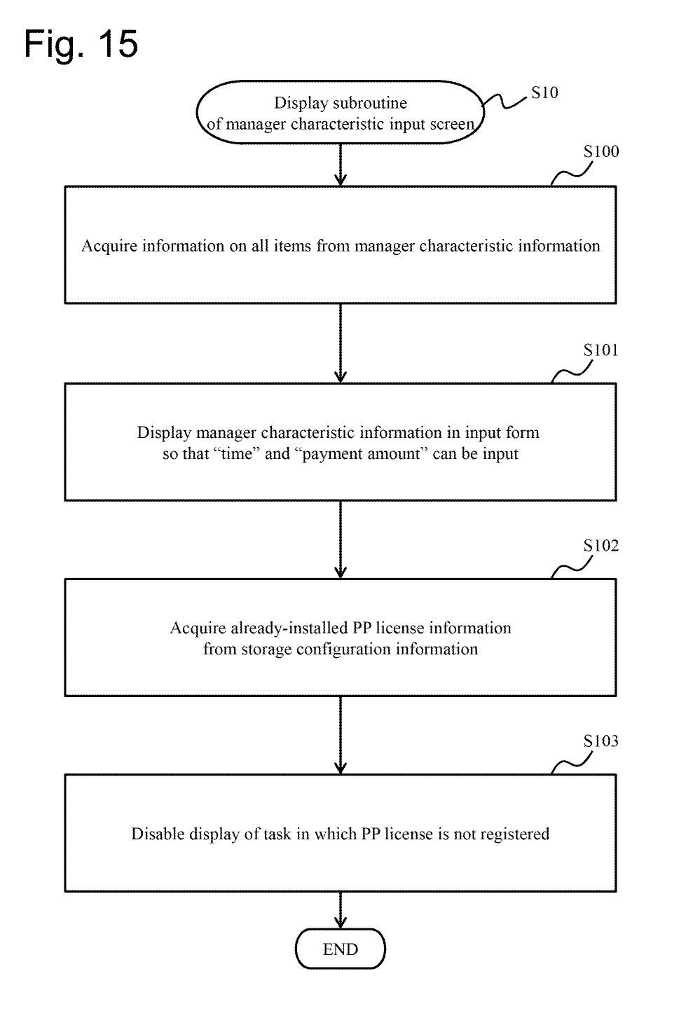

With reference to FIG. 14 to FIG. 20, a method of managing a storage system will be described. Flowcharts in FIG. 14 and FIG. 15 show a process of inputting data into the manager characteristic information 317. The data center manager uses the data-center-side display computer 60 so as to log in to the task allocation computer 30, and starts running the manager characteristic input program 310.

The manager characteristic input program 310 displays the screen G10 for inputting the manager characteristic information on the data-center-side display computer 60 (S10). This step S10 will be described in detail later in FIG. 15.

The manager characteristic input program 310 acquires the task, the time, and the payment amount input from the data center manager (S11). In this case, the data center manager does not need to input the task identifier into the screen G10. This is because it is possible to determine the task having a value configured to the payment amount and the time as a task executable by the storage manager.

The manager characteristic input program 310 saves the information acquired from the screen G10 into the manager characteristic information 317 (S12).

With reference to FIG. 15, step S10 in FIG. 14 will be described in detail. The manager characteristic input program 310 acquires information on all the items included in the manager characteristic information 317 (S100). The manager characteristic input program 310 displays all the acquired items on the screen G10, i.e., an input form, and the sections for “time” and “payment amount” are inputtable (S101).

The manager characteristic input program 310 acquires PP license information already installed into the storage apparatus 21 from the storage configuration information 314 (S102).

The manager characteristic input program 310 does not display a task that cannot be executed because the PP license is not registered yet, on the screen G10 (S103). Alternately, the manager characteristic input program 310 is capable of displaying the task that cannot be executed in a manner that disables input.

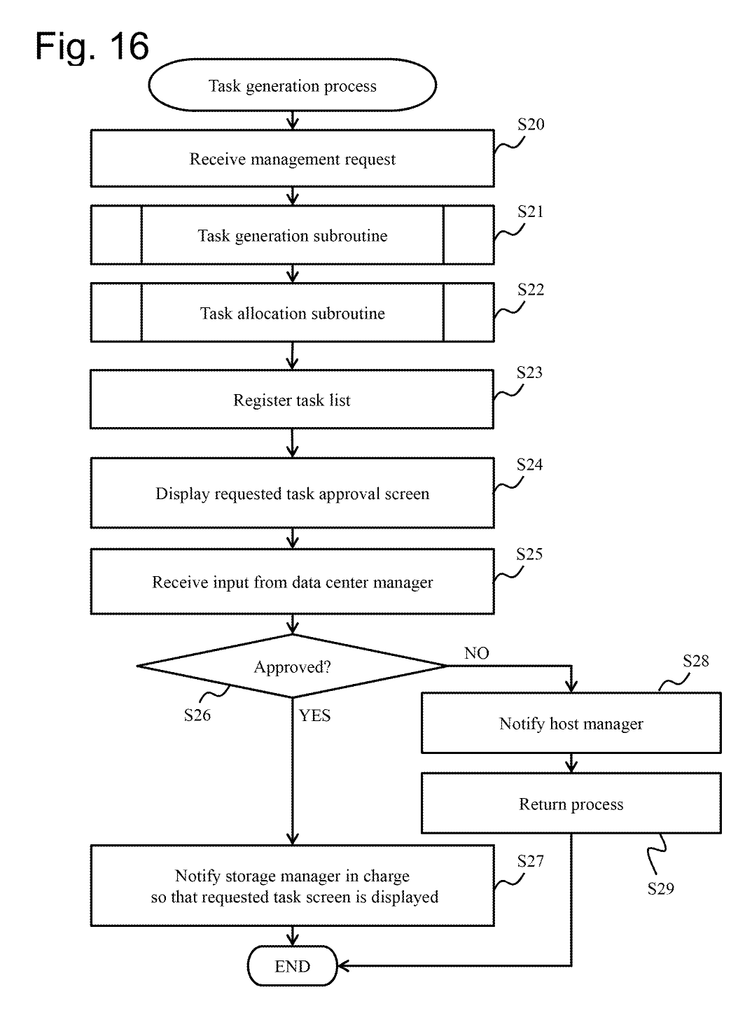

The flowchart in FIG. 16 shows a series of processes in which the task is generated from the management request, the generated task is allocated to the storage manager, the approval of the data center manager is obtained, and then, the task is requested to each storage manager.

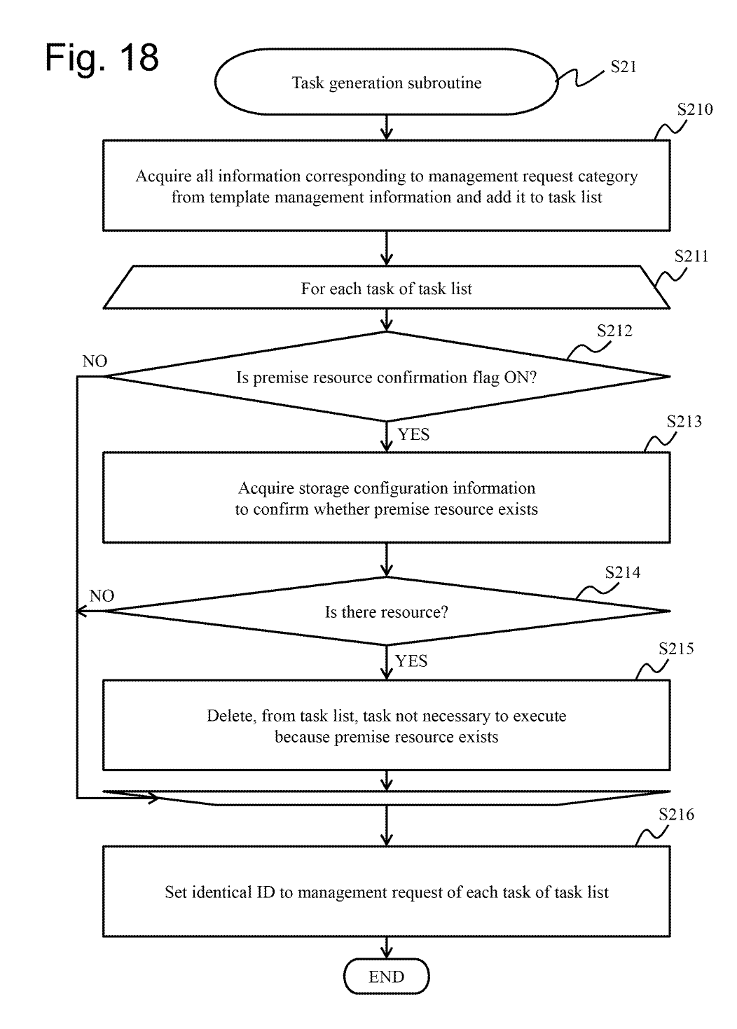

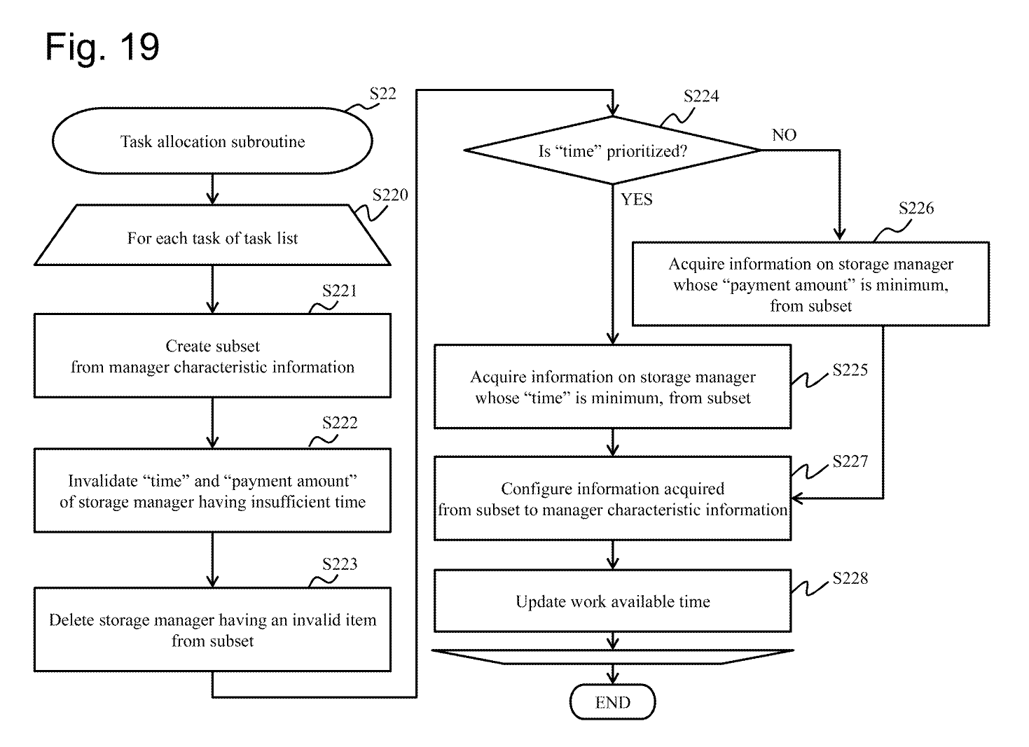

Upon receipt of the management request created by the host manager from the host-side display computer 50 (S20), the task generation program 312 executes a task generation subroutine described later in FIG. 18 (S21). Further, the task generation program 312 executes a task allocation subroutine described later in FIG. 19 (S22). As a result, the task generation program 312 creates a task list as a draft plan indicating to which storage manager each task for realizing the management request is allocated so that the task is executed.

The task generation program 312 registers the task list, which is generated in step S21 and step S22, with the task management information 318 (S23). Concurrently with the registration, the task generation program 312 updates so that the work status of a first task (ID of the smallest task) is “work in progress” and the work status of the other tasks is “not implemented”.

The task generation program 312 refers to the task management information 318, displays the requested task approval screen G30 on the data-center-side display computer 60, and waits for the approval or disapproval by the data center manager (S24). The task generation program 312 receives information indicating either approval or disapproval from the data center manager (S25).

The task generation program 312 determines whether the draft plan is approved by the person responsible for a data center (S26). When the approval is determined (S26: YES), the task generation program 312 notifies each storage manager, to whom a task is to be requested, and presents the requested task screens G40 to G42 (S27). The notified storage manager is capable of confirming the requested task via the storage-side display computer 70.

When it is determined that the draft plan is not approved by the data center manager (S26: NO), the task generation program 312 notifies the host manager, from which the management request is made, of the disapproval of the draft implementation plan of the management request (S28). The host manager is capable of confirming the notification via the host-side display computer 50. The task generation program 312 returns a process rendered unnecessary due to the disapproval of the implementation of the management request to the original state (S29), and then, ends the process (S29).

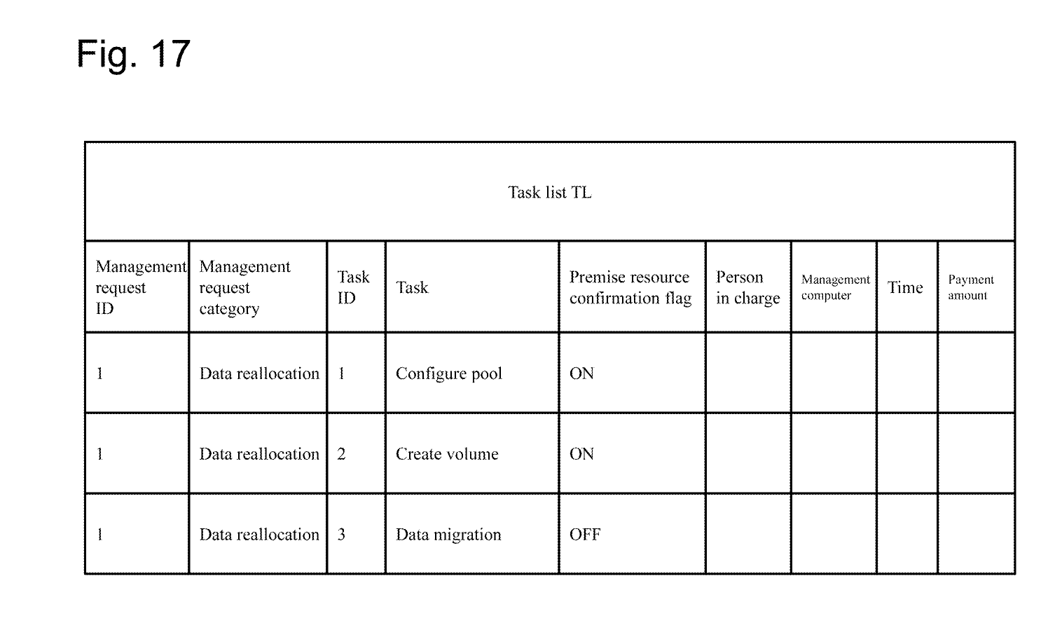

FIG. 17 shows an example of a task list TL. The task list TL holds information on each task for realizing the management request. The task list TL includes a section for a management request ID, a management request category, a task ID, a task, a premise resource confirmation flag, a person in charge, a management computer, a time, and a payment amount.

The management request ID is information for distinguishing the management request. The management request category is information for differentiating a kind of the management request. The task ID is information for distinguishing a task generated from the management request. The task is a name or a content of a task.

The premise resource confirmation flag is information indicating whether it is necessary to confirm the presence of a predetermined resource before executing the task, as described above. The person in charge is information for distinguishing a storage manager that requests to execute a task. The management computer is information for distinguishing the storage management computer 40 used to execute a task. The time is a work time and the payment amount is a payment amount for work. At a time point at which the task list TL is generated in step S21 described later in FIG. 18, the storage manager that is a candidate, to whom the task is to be allocated, is not decided yet, and thus, a value is not configured to the section for a person in charge, the storage management computer section, the time section, and the payment amount section.

The flowchart in FIG. 18 gives a detailed description of the task generation subroutine shown in step S21 in FIG. 16.

The task generation program 312 acquires all the information corresponding to the management request category from the template management information 316, and adds the same to the task list TL (S210). That is, the task generation program 312 acquires information on the task ID, the task name (task content), the premise resource confirmation flag of all the tasks necessary to realize the management request, and registers the same with the task list TL.

The task generation program 312 executes steps S212 to S215 described below, for each task registered with the task list TL (S211). Hereinafter, a task subject to process may be called a target task. Further, the premise resource confirmation flag may be abbreviated as a confirmation flag.

The task generation program 312 determines whether the confirmation flag on the target task is ON (S212). When it is determined that the confirmation flag is not ON (S212: NO), the task generation program 312 returns to step S211 to select a next task as the target task.

When it is determined that the confirmation flag is ON (S212: YES), the task generation program 312 acquires the storage configuration information 314 and confirms whether a resource as a premise exists (S213). The task generation program 312 determines whether the premise resource exists (S214).

When it is determined that the premise resource does not exist (S214: NO), the task generation program 312 returns to step S211 to select a next task as the target task. When it is determined that the premise resource already exists (S214: YES), the task generation program 312 deletes the task rendered unnecessary to execute from the task list TL (S215). For example, as viewed from the volume creation task, the pool being configured is a premise, and the pool is the premise resource. In this case, when the pool for creating the volume is already prepared, it is not necessary to execute the pool configuration task. This is because it may suffice to use the existing pool. Therefore, in step S215, the task generation program 312 deletes an unnecessary task from the task list TL.

When the task generation program 312 executes the processes in steps S212 to S215 on all the tasks registered with the task list TL, the task generation program 312 sets the same ID to the management requests of all the tasks left on the task list TL (S216). The management request ID is a unique value in the storage system.

The flowchart in FIG. 19 gives a detailed description of the task allocation subroutine shown in step S22 in FIG. 16. The task generation program 312 executes each of steps S221 to S228 described below, for each task registered with the task list TL created in the process in FIG. 18.

The task generation program 312 acquires information on a row including the target task, from the manager characteristic information 317, and temporarily generates a subset of the manager characteristic information 317 (S221). The task generation program 312 invalidates, in the subset, items of “time” and “payment amount” for the storage manager having an insufficient work time (S222). That is, this is because it is not possible to allocate any more work to a storage manager in which the work time necessary to execute the task exceeds the work available time acquired from the manager work amount information 319.

The task generation program 312 deletes the column of the storage manager having an invalidated item in the “time” and the “payment amount”, from the subset (S223). When the storage manager that cannot be selected as a candidate is removed from a process target, the subsequent process can be simplified. For example, in the example in FIG. 11, when the data migration task is focused, a storage manager #2 has an invalidated section for the time and the payment amount. Therefore, the task generation program 312 deletes the column of the storage manager #2 from the subset.

The task generation program 312 refers to the priority item of the management request to determine whether the “time” is prioritized (S224). When it is determined that a time priority is configured (S224: YES), the task generation program 312 acquires a value of the “time” and the “payment amount” regarding a storage manager having the shortest work time, from the subset (S225).

When it is determined that the priority item of the management request is not the time (S224: NO), the task generation program 312 acquires the value of the “time” and the “payment amount” of the storage manager having the smallest payment amount for work, from the subset (S226).

The task generation program 312 configures the information (person in charge of storage, the time, and the payment amount) acquired from the subset, to the task list TL (S227). The task generation program 312 subtracts a time required for the allocated task, from the “work available time” of the storage manager (storage manager to which the task is allocated) selected as the person in charge, and updates the manager work amount information 319 (S228).

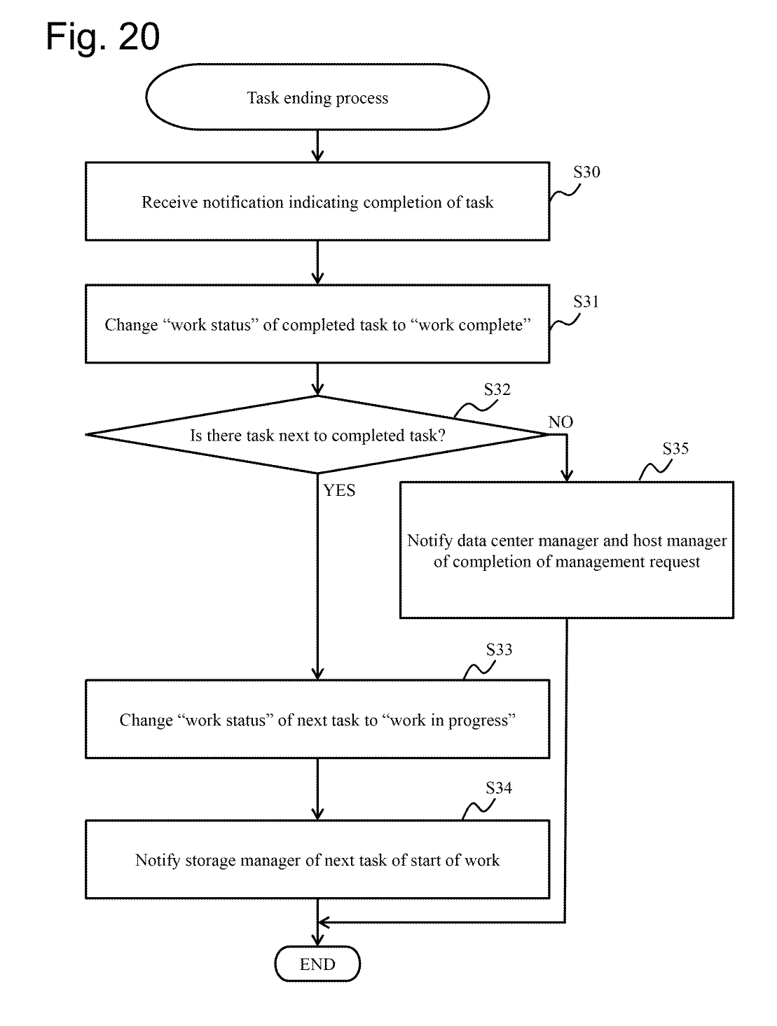

FIG. 20 shows a flowchart of a task ending process. Each storage manager to which the task corresponding to the management request is allocated accesses the storage management computer 40 from the storage-side display computer 70, and operates the configuration of the storage apparatus 21 by using the storage management computer 40. As a result, the storage manager executes the allocated task. Once the completion of the task allocated to the storage manager is confirmed, the storage manager notifies the task allocation computer 30 of the completion.

Upon receipt of a task completion notification from the storage manager (S30), the task ending program 313 changes the work status of the notified task to “completed”, and updates and saves the task management information 318 (S31).

The task ending program 313 determines whether there is a task that should be executed next to the completed task (S32). As described above, each task generated from the management request is executed according to a predetermined order so that the management task is realized.

Upon determination that there is a next task (S32: YES), the task ending program 313 changes the work status of the next task to “work in progress”, and updates and saves the task management information 318 (S33). The task ending program 313 notifies the storage manager in charge of the next task to start the work (S34). The notified storage manager executes the task allocated to the notified storage manager, and upon completion of the task, notifies the task allocation computer 30.

When all the tasks are executed orderly, the task ending program 313 determines that there is no next task (S32: NO) and notifies the data center manager and the host manager from which the management request is made, of the completion of the management request (S35). The data center manager knows the completion of the management request via the data-center-side display computer 60. The host manager knows the completion of the management request via the host-side display computer 50.

According to the present embodiment configured as described above, the following effects can be obtained. In the present embodiment, a plurality of tasks are generated from the management request and the storage manager is allocated for each task, and thus, it is possible to execute one management request among the plurality of storage managers depending on each capability, etc. Therefore, as compared to a case where one storage manager is in charge of a whole of the management request, it is possible to better take advantage of the capability of each storage manager, it is possible to improve a management duty efficiency as a whole system (as a whole of the data center), and it is possible to restrain an increase in management cost.

In the present embodiment, in view of a plurality of aspects such as the work time and the payment amount for work, the storage manager to which a task is allocated is selected. Therefore, it is possible to cope with both a case where the management request is prioritized over a total work time and a case where a total payment amount for work is prioritized. Thus, according to the convenience of the host manager from which the management request is made, it is possible to effectively execute the management work, resulting in improvement of use.

In the present embodiment, a task execution capability (skill) of the storage manager is managed for each vendor, and thus, as compared to a method in which the storage manager is allocated to each vendor, it is possible to better take advantage of a capability of a storage manager capable of dealing with a plurality of different vendors. As a result, it is possible to perform a management duty by effectively using a human resource (each storage manager) provided in a system.

In the present embodiment, the task is executed after confirming the existence of a necessary resource upon execution, and thus, it is possible to restrain a meaningless wait time such as waiting for generation of a resource, and it is possible to increase the management work efficiency.

In the present embodiment, once one task is completed, the storage manager, to whom a next task is to be allocated, is instructed to execute the next task. Therefore, it is possible to realize the management request by executing a plurality of tasks according to a predetermined order.

In the present embodiment, a daily work available time of each storage manager is managed, and thus, it is possible to prevent a large amount of tasks from being allocated to a particular storage manager.

In the present embodiment, the data center manager or the storage manager is capable of referring to a history of the task management information 318. Therefore, the data center manager is capable of comprehending a work status, a capability, etc., of each storage manager. Each storage manager is capable of considering a capability improvement of each storage manager from the history of the task management information 318.

### EMBODIMENT 2

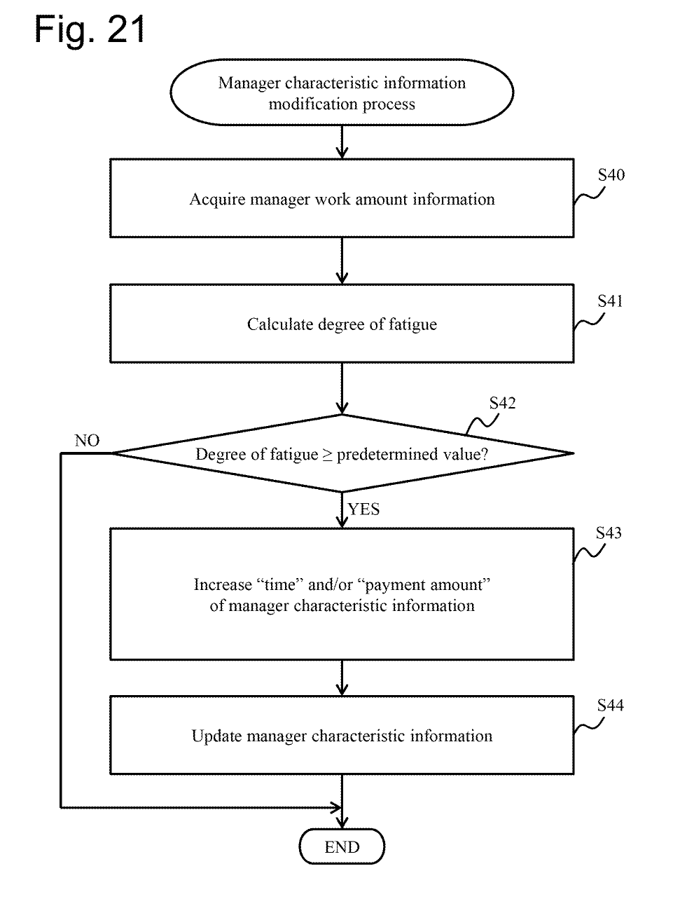

With reference to FIG. 21, a second embodiment will be described. The present embodiment corresponds to a modification of the first embodiment, and thus, description proceeds with a particular focus on a difference from the first embodiment. In the present embodiment, on the basis of the manager work amount information 319 as an example of “storage manager information”, a configuration value of the manager characteristic information 317 is modified.

FIG. 21 shows a flowchart of a process for modifying the manager characteristic information 317. The present process is executed by the task allocation computer 30. The present process may be executed by either the task generation program 312 or the task ending program 313, for example. In this case, description proceeds with a case where it is the task allocation computer 30 that executes the process. The task allocation computer 30 is capable of executing the present process each time the task or the management request is ended. Alternately, the task allocation computer 30 is capable of executing the present process on the basis of the instruction of the data center manager or at a predetermined time every day.

The task allocation computer 30 acquires the manager work amount information 319 (S40), and calculates the degree of fatigue of each storage manager from a value of the “work available time” (S41). It is possible to predict the degree of fatigue of the storage manager is correlated with an accumulated value of the work available time in a certain fixed period, for example. Therefore, for example, when an accumulated value of the work available time, an age of the storage manager, years of experience, etc., are taken into consideration, it is possible to calculates the degree of fatigue for estimating the fatigue of the storage manager.

The task allocation computer 30 compares the calculated degree of fatigue with a predetermined value that is configured in advance, and determines whether the degree of fatigue is equal to or more than the predetermined value (S42). When the degree of fatigue is less than the predetermined value (S42: NO), the present process is ended.

When the degree of fatigue is equal to or more than the predetermined value (S42: YES), the task allocation computer 30 increases a value of the “work time” and/or the “payment amount for work” of the manager characteristic information 317 for a storage manager having a degree of fatigue equal to or more than the predetermined value (S43). Then, the task allocation computer 30 updates and saves the manager characteristic information 317 (S44).

When at least either one of the values of the work time or the payment amount for work of the fatigued storage manager is changed to a larger value, a chance of the storage manager being selected as a person responsible for executing a task is decreased.

It should be noted that when the manager characteristic information 317 is modified on the basis of the manager work amount information 319, the manager characteristic information 317 may be displayed so as to be distinguished from another value by displaying a modified value in bold, changing the color thereof, and blinking the same on the manager characteristic information input screen G10 so that the automatic modification is made obvious.

The present embodiment thus configured provides an operation and effect in much the same way as in the first embodiment. Further, in the present embodiment, the degree of fatigue of the storage manager is estimated so as to automatically modify the value of the manager characteristic information 317, and thus, it is possible to decrease the frequency of allocating a task to the storage manager having an accumulated fatigue and it is thus possible to appropriately distribute a task to each storage manager. Further, it is possible to prevent the generation of a man-made mistake by the fatigued storage manager, and thus, it is possible to increase the reliability of a management work.

The present invention is not limited to the above-described embodiments. A person skilled in the art can perform various additions, modifications, etc., within the scope of the present invention. For example, the technological characteristics of the above-described present invention can be combined and implemented where necessary.

### REFERENCE SIGNS LIST

10: host computer, 20: storage cluster, 21: storage apparatus, 30: task allocation computer, 40: storage management computer, 50, 60, 70: display computer

1-3. (canceled)

4. A storage system management computer configured to manage a storage system including one or more storage apparatuses used by a host computer, comprising:
a memory part; and a processor part configured to perform a predetermined calculation by executing a predetermined computer program stored in the memory part, wherein:
the processor part is configured to:
store, into the memory part, manager capability information on a task execution capability provided in a plurality of storage managers and management request—task management information defining a correspondence relation between a management request regarding a management of the storage system and a task for realizing the management request;
receive a management request regarding a management of the storage system;
generate a plurality of tasks for realizing the received management request on the basis of the management request—task management information; and
allocate for each task, a predetermined storage manager selected out of the storage managers capable of executing a task out of each of the storage managers, as a person responsible for executing a task for each of the generated tasks, on the basis of the manager capability information, wherein:
the manager capability information includes information for distinguishing a task executable by each of the storage managers, a work time required for executing the executable task and a payment amount for work required for executing the executable task and wherein
the manager capability information is configured to manage the information for distinguishing the executable task, the work time, and the payment amount for work for each vendor of the storage apparatus.

5. A storage system management computer according to claim 4, wherein
the manager capability information can be configured only to a task regarding a function provided in the storage apparatus.

6. A storage system management computer according to claim 5, wherein
the manager capability information is modified by using storage manager information on each storage manager.

7. A storage system management computer according to claim 6, wherein
the processor part is configured to generate the task after confirming that a resource necessary to generate the task exists.

8. A storage system management computer according to claim 7, wherein
the processor part is configured to select the predetermined storage manager from among the storage managers capable of executing the task, on the basis of a previously set predetermined condition, and
the predetermined condition is equal to or less than an upper limit value of a predetermined work time to which the work time of the storage manager is previously configured.

9. A storage system management computer according to claim 8, wherein
the predetermined condition further includes either one of: a storage manager whose work time is minimum out of each of the storage managers; or a storage manager whose payment amount for work is minimum out of each of the storage managers.

10. A storage system management computer according to claim 9, wherein
upon receipt of a notification for informing of a completed task out of each of the tasks, the processor part is configured to notify the storage manager that is a person responsible for executing a task to be executed next that the task in charge should be executed.

11. A storage system management computer according to claim 10, wherein
the processor part is coupled, via a communication part, to a host-management operation computer used for managing the host computer, a storage-management operation computer used for managing the storage apparatus, and a system-management operation computer used for managing the storage system,
the processor part is configured to:
output and display, to and on the host-management operation computer, a result that the predetermined storage manager is allocated as the person in charge of execution; and
when receiving information indicating an approval from the host-management operation computer, notify the storage-management operation computer used by the predetermined storage manager of being allocated as a person responsible for executing the task.

12. (canceled)
